(19) United States
(12) Patent Application Publication
(10) Pub. No.: US 2006/0149718 A1
(43) Pub. Date: Jul. 6, 2006

(54) Image forming apparatus

(76) Inventor: Hiroki Ohzaki, Kanagawa (JP)

Correspondence Address: HARNESS, DICKEY & PIERCE, P.L.C., P.O. BOX 8910, RESTON, VA, 20195, US

(21) Appl. No.: 11/298,620

(22) Filed: Dec. 12, 2005

(30) Foreign Application Priority Data
Dec. 13, 2004 (JP) 2004-360509

(51) Int. Cl. G06F 17/30; G06F 7/00

(52) U.S. Cl. 707/3

(57) ABSTRACT

An image forming apparatus stores documents, and performs an operation by specifying a document for which the operation is to be performed from a list of documents displayed. The image forming apparatus includes an error-information storage unit that stores an error information including information on a document for which the operation has failed to be completed; and a display unit that displays the list while discriminating the documents for which the operation has failed from documents for which the operation has succeeded, based on the error information.

### CROSS-REFERENCE TO RELATED APPLICATIONS

The present document incorporates by reference the entire contents of Japanese priority document, 2004-360509 filed in Japan on Dec. 13, 2004.

### BACKGROUND OF THE INVENTION

1. Field of the Invention

The present invention relates to an image forming apparatus in which various operations for documents are instructed on a screen displaying a list of the documents.

2. Description of the Related Art

Image forming apparatuses in which various operations, such as printing, are instructed from a list of stored documents displayed on a screen have been developed.

In a conventional technology disclosed in, for example, Japanese Patent Application Laid-Open No. H5-219287, a central processing unit (CPU) sequentially records transmission results of fax data using a fax adapter, and when a specific search item is instructed by a pointing device, the CPU creates a desired transmission log file based on the transmission results of the fax data to inform the transmission results of data that has already been transmitted. Moreover, in a technology disclosed in, for example, Japanese Patent Application Laid-Open No. 2002-027161, instead of automatically printing out document in data received by a fax, the data is stored in a hard disk (HD), and attribute information, such as received date and time, and a sender, of the data is stored in a random access memory (RAM). The attribute information is managed by creating a print job table in which all print jobs are collectively written in a table. Instead of automatically printing out fax reports indicating power OFF, or a transmission error, for the data, contents of the fax report and time of generating the fax report are stored in the print job table. When a display of a print document list is instructed on an operation panel, a list of the received documents and the report information are displayed in the print job table, and document or information to be printed are selected from the list.

In the conventional technology, however, if an operation that is instructed by a user fails to be completed, it is difficult to find a document for which the operation has not been completed.

For example, although printing is instructed for one of the documents on the list, if specified paper is not placed on a paper feed tray, or color toner has run out, the document cannot be printed.

To perform such operation again for the document for which the operation has failed to be completed, the user has to find the document from the list based on document names or the like.

### SUMMARY OF THE INVENTION

It is an object of the present invention to at least solve the problems in the conventional technology.

An image forming apparatus according to one aspect of the present invention stores documents, and performs an operation by specifying a document for which the operation is to be performed from a list of documents displayed. The image forming apparatus includes an error-information storage unit that stores an error information including information on a document for which the operation has failed to be completed; and a display unit that displays the list while discriminating the documents for which the operation has failed from documents for which the operation has succeeded, based on the error information.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an image forming apparatus according to a first embodiment of the present invention;

FIG. 2 is a flowchart of a processing to perform an operation for a document in the image forming apparatus shown in FIG. 1;

FIG. 3 is a flowchart of a list display operation in the image forming apparatus shown in FIG. 1;

FIG. 4 is a schematic of a list of stored documents when there is no document for which an operation has failed to be complete;

FIG. 5 is a flowchart of a list display operation in an image forming apparatus according to a second embodiment of the present invention;

FIG. 6 is a schematic of a list of stored documents in which documents for which an operation has failed to be completed are selected;

FIG. 7 is a flowchart of a list display operation in an image forming apparatus according to a third embodiment of the present invention;

FIG. 8 is a schematic of a list including an error display button;

FIG. 9 is a schematic of a list in which only documents for which an operation has failed are displayed;

FIG. 10 is a flowchart of a list display operation in an image forming apparatus according to a fourth embodiment of the present invention;

FIG. 11 is a schematic of a list in which an error icon is added to a document for which an operation has failed;

FIG. 12 is a flowchart of a processing to perform an operation in an image forming apparatus according to a fifth embodiment of the present invention;

FIG. 13 is a flowchart of a list display operation in the image forming apparatus according to the fifth embodiment;

FIG. 14 is a schematic of a list in which an error count is added to a document for which an operation has failed;

FIG. 15 is a flowchart of a list display operation in an image forming apparatus according to a sixth embodiment of the present invention;

FIG. 16 is a schematic of a list in which documents for which an operation has failed are shifted upward to be displayed on the top of the list;

FIG. 17 is a flowchart of a list display operation in an image forming apparatus according to a seventh embodiment of the present invention; and

FIG. 18 is a schematic of a list in which a background color for a document for which an operation has failed is made different from that of documents for which the operation has succeeded.

### DETAILED DESCRIPTION OF THE PREFERRED EMBODIMENTS

Exemplary embodiments of the present invention are explained in detail below with reference to the accompanying drawings.

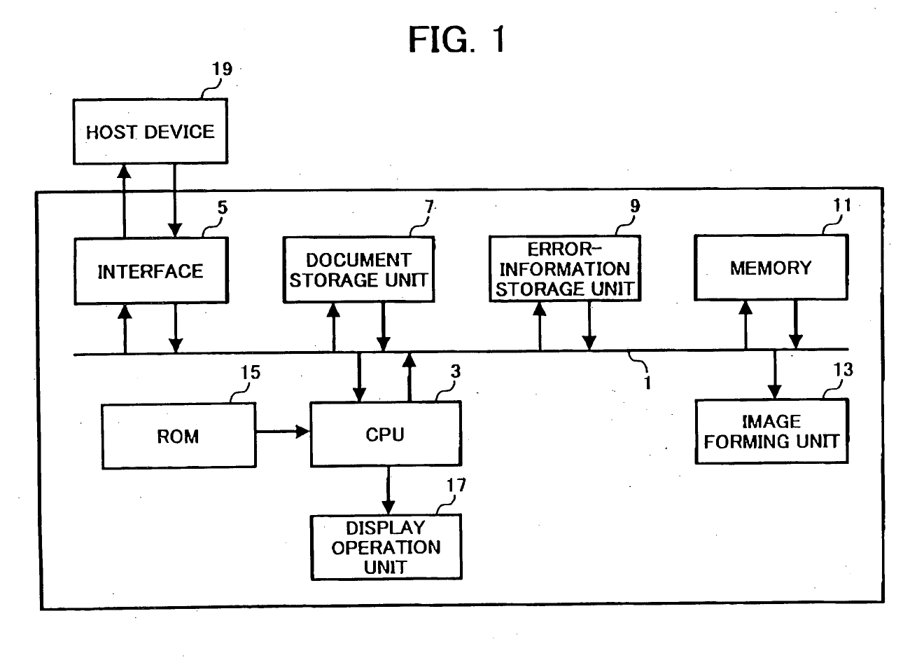

FIG. 1 is a schematic of an image forming apparatus according to a first embodiment of the present invention. As shown in FIG. 1, the image forming apparatus includes a CPU 3, an interface 5, a document storage unit 7, an error-information storage unit 9, a memory 11, and an image forming unit 13 connected to each other via an internal bus 1. A read-only memory (ROM) 15, and a display operation unit 17 are connected to the CPU 3. A host device 19 is connected to the interface 5.

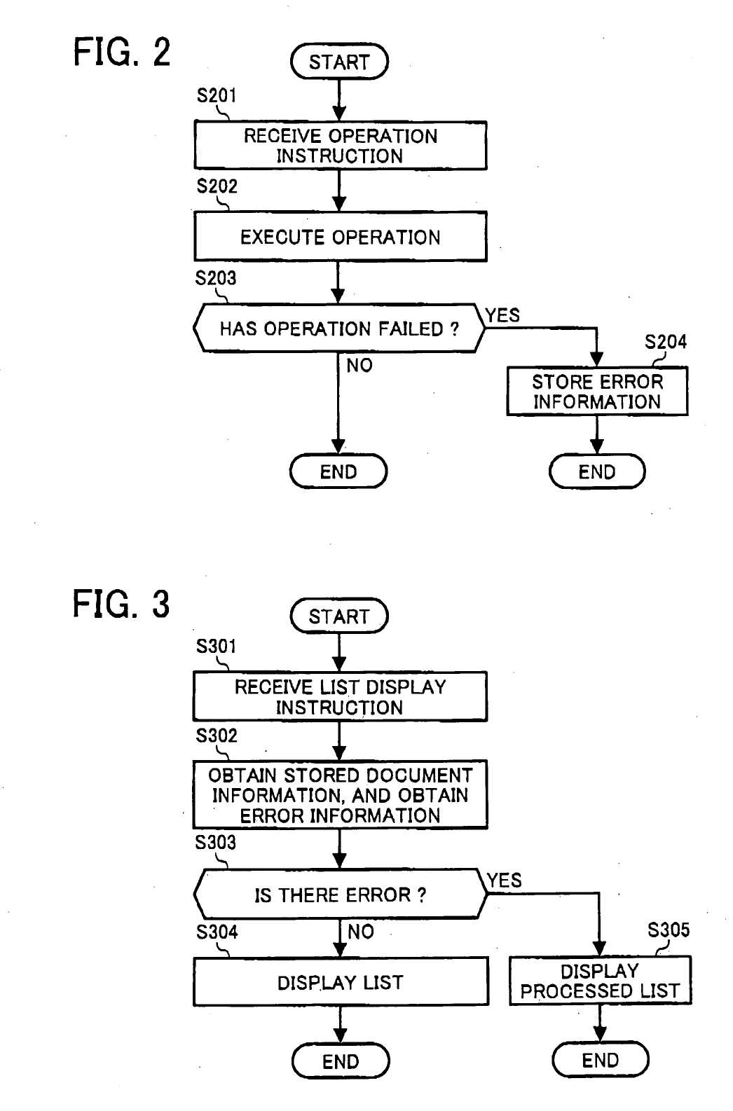

FIG. 2 is a flowchart of a processing to perform an operation for a document in the image forming apparatus shown in FIG. 1. As shown in FIG. 2, when the CPU 3 receives an instruction to perform an operation, such as printing and deletion, for a document selected from a list of documents stored in the document storage unit 7, by a user via the display operation unit 17 (step 201), the CPU 3 executes the operation (step 202). After executing the operation, the CPU 3 determines whether the operation has failed to be completed (step 203). When the operation has failed, the CPU 3 stores information on the document for which the operation has failed (hereinafter, “failed document”) in the error-information storage unit 9 as error information (step 204).

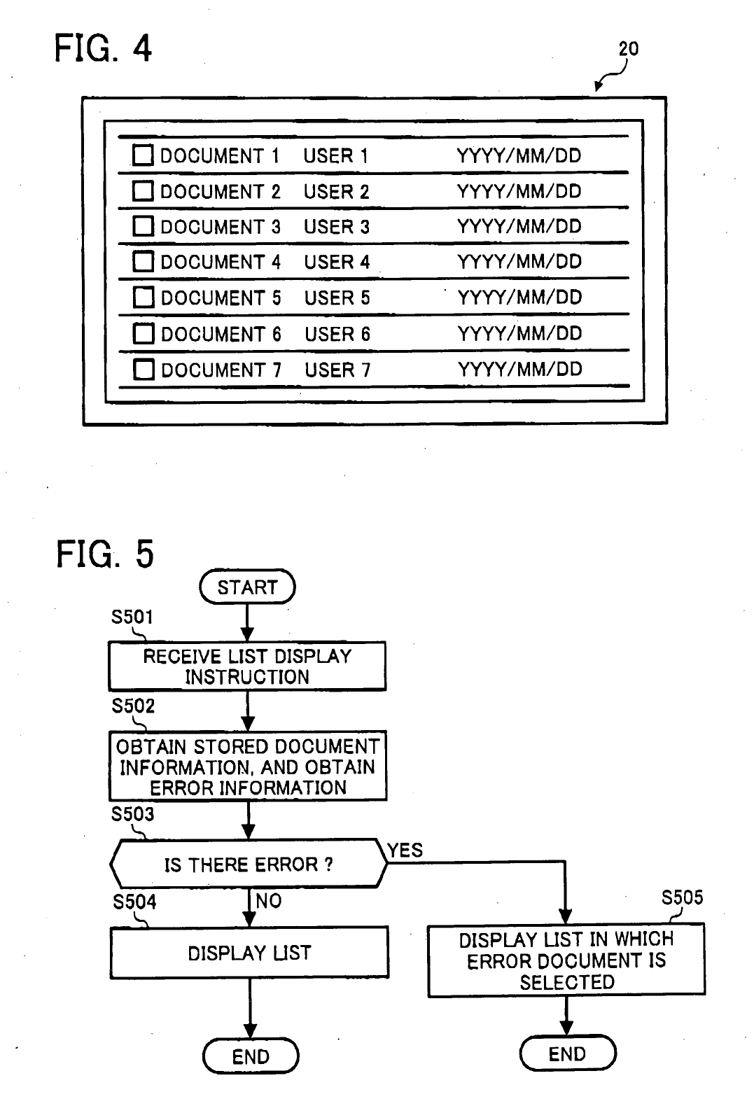

FIG. 3 is a flowchart of a list display operation in the image forming apparatus shown in FIG. 1. FIG. 4 is a schematic of a list of stored documents when there is no failed document. As shown in FIG. 3, upon receiving an instruction to display the list of stored documents via the display operation unit 17 (step 301), the CPU 3 obtains information on the stored document from the document storage unit 7, and error information from the error-information storage unit 9 (step 302). The CPU 3 then determines whether there is error information in the error-information storage unit 9 (step 303), and when there is no error information indicating a failed document, the CPU 3 displays a list 20 of the stored documents as shown in FIG. 4 (step 304). When there is error information indicating a failed document, the CPU 3 processes the list so that the failed document can be easily found on the list, and displays processed list. (step 305).

Since the failed document can be easily found on the list screen, the operability can be improved when some operation is performed again for the failed document.

A processing to perform an operation for a document in an image forming apparatus according to a second embodiment of the present invention is the same as that explained in the first embodiment.

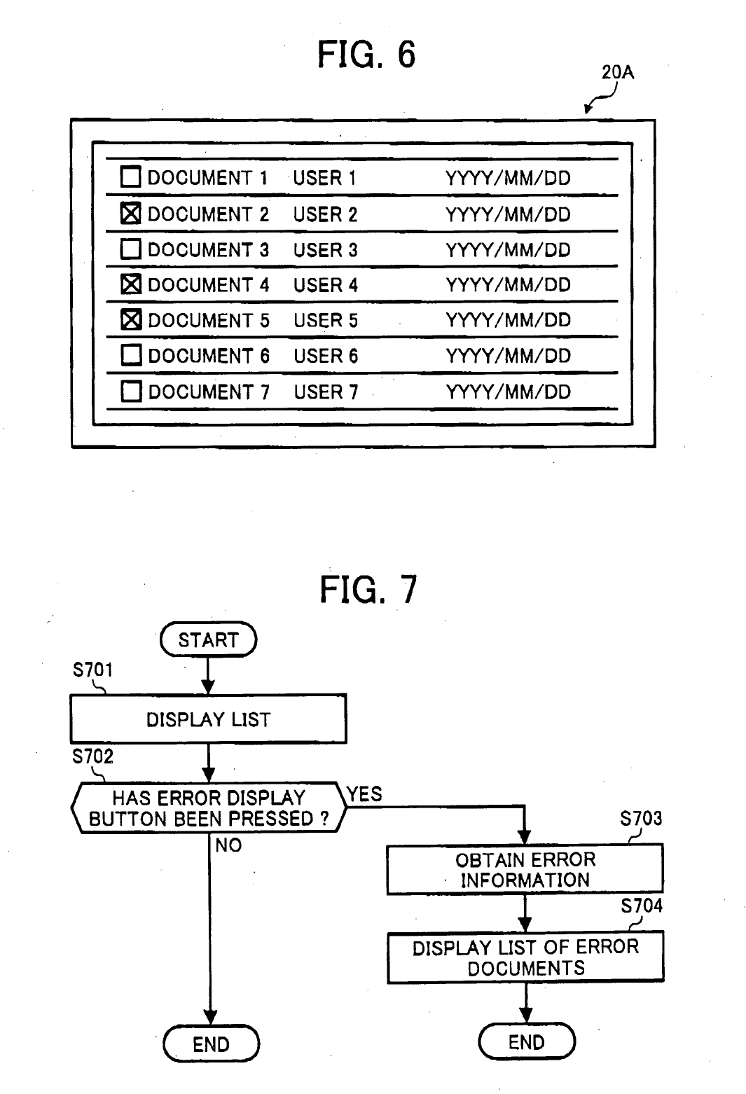

FIG. 5 is a flowchart of a list display operation in the image forming apparatus according to the second embodiment. As shown in FIG. 5, upon receiving an instruction to display a list of stored documents via the display operation unit 17 (step 501), information on the stored document from the document storage unit 7, and error information from the error-information storage unit 9 (step 502). The CPU 3 then determines whether there is error information indicating a failed document in the error-information storage unit 9 (step 503), and when there is no error information indicating a failed document, the CPU 3 displays the list 20 of the stored documents as shown in FIG. 4 (step 504). When there are failed documents, the CPU 3 displays a list 20A in which the failed documents (documents 2, 4, 5) are selected according to the error information, so that the failed document can be easily found on the list as shown in FIG. 6 (step 505). FIG. 6 is a display example of the list screen when a failed document is selected.

Since the failed documents displayed being selected on the list, the failed documents can be easily found, thereby improving the operability when an operation is to be performed again for the failed documents.

A processing to perform an operation for a document in an image forming apparatus according to a third embodiment of the present invention is the same as that explained in the first embodiment.

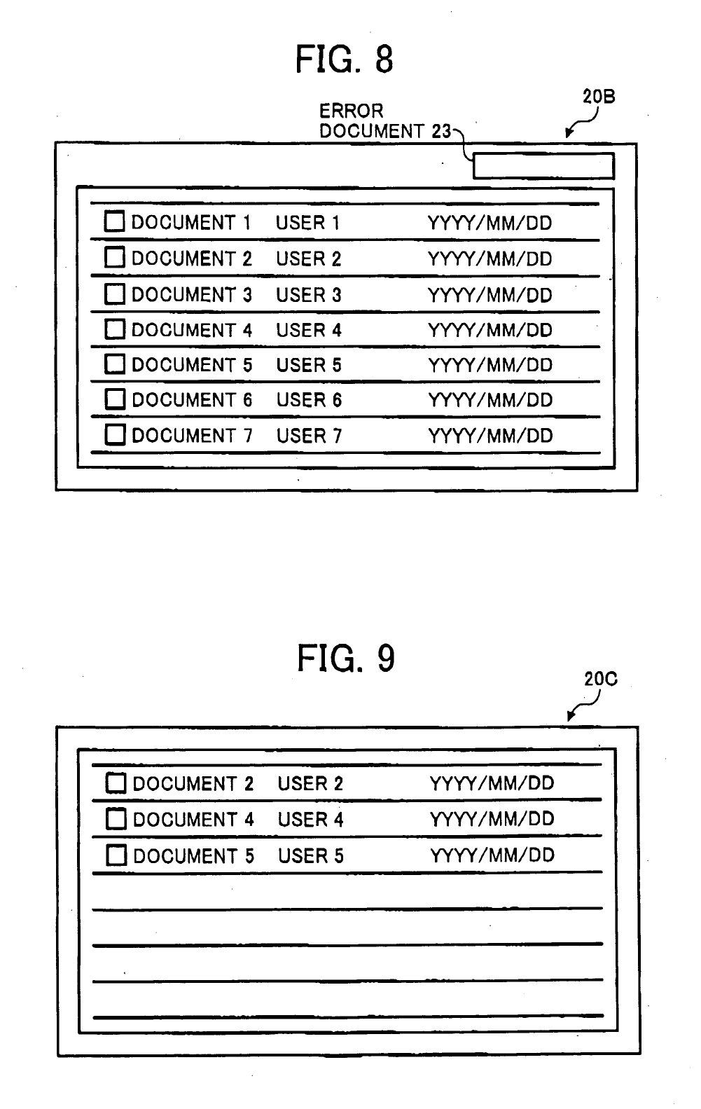

FIG. 7 is a flowchart of a list display operation in the image forming apparatus according to the third embodiment. FIG. 8 is a schematic of a list including an error display button, and FIG. 9 is a schematic of the list in which only for failed documents are displayed. As shown in FIG. 7, upon receiving an instruction to display a list of stored documents via the display operation unit 17, the CPU 3 obtains information on the stored documents from the document storage unlit 7 to display a list 20B as shown in FIG. 8 including an error display button 23 (step 701). The CPU 3 then determines whether the error display button 23 is pressed (step 702). When the error display button 23 is pressed, the CPU 3 obtains the error information from the error-information storage unit 9 (step 703). The CPU 3 then displays a list 20C as shown in FIG. 9 in which only the failed documents (documents 2, 4, 5) are displayed (step 704). Thus, the failed documents can be easily found.

Since only the failed documents are displayed on a list, the failed documents can be easily found, thereby improving the operability when some operation is to be performed again for the failed document.

A processing to perform an operation for a document in an image forming apparatus according to a fourth embodiment of the present invention is the same as that explained in the first embodiment.

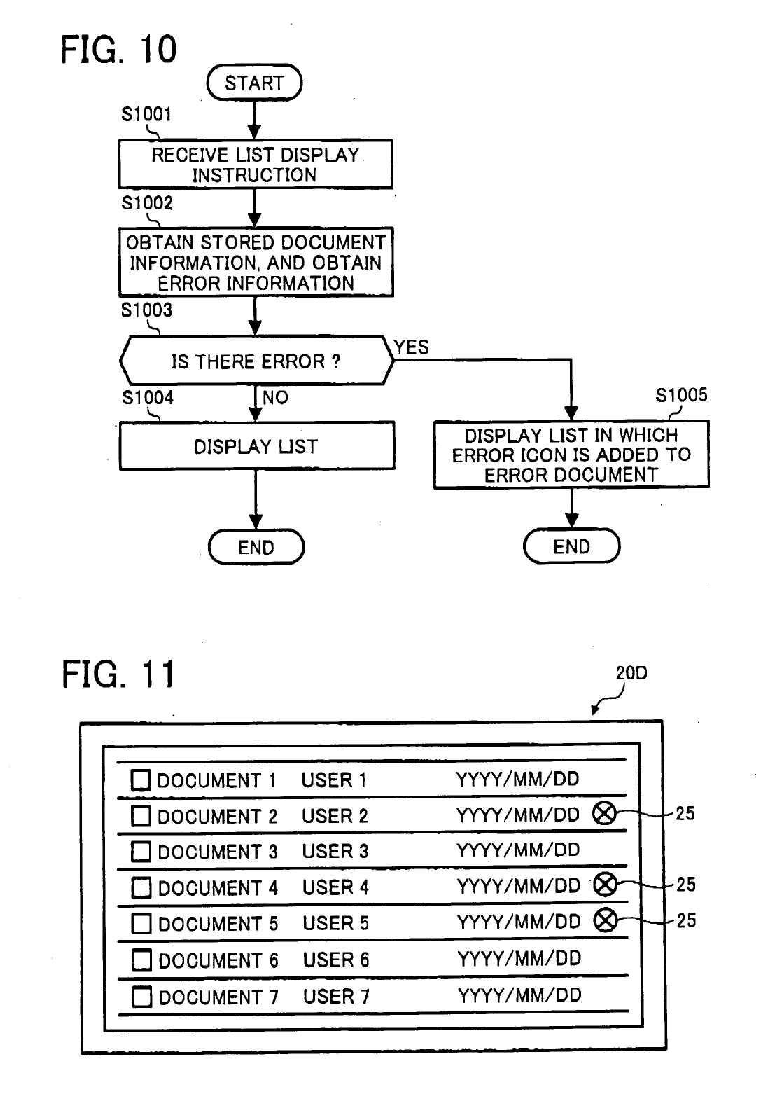

FIG. 10 is a flowchart of a list display operation in the image forming apparatus according to the fourth embodiment. FIG. 11 is a schematic of a list in which an error icon 25 is added to the failed documents. As shown in FIG. 10, upon receiving an instruction to display a list of stored documents via the display operation unit 17 (step 1001), the CPU 3 obtains information on the stored document information from the document storage unit 7, and obtains the error information indicating a failed document from the error-information storage unit 9 (step 1002). The CPU 3 then determines whether there is error information indicating a failed document in the error-information storage unit 9 (step 1003), and when there is no failed document, the CPU 3 displays the list 20 as shown in FIG. 4 (step 1004). When there re failed documents, the CPU 3 displays a list 20D, as shown in FIG. 11, in which the error icon 25 is added to the failed documents (documents 2, 4, 5) according to the error information (step 1005). Thus, the failed documents can be easily found.

Since the error icon 25 is added to the failed documents on the list, the failed documents can be easily found, thereby improving the operability when some operation is to be performed again for the failed documents.

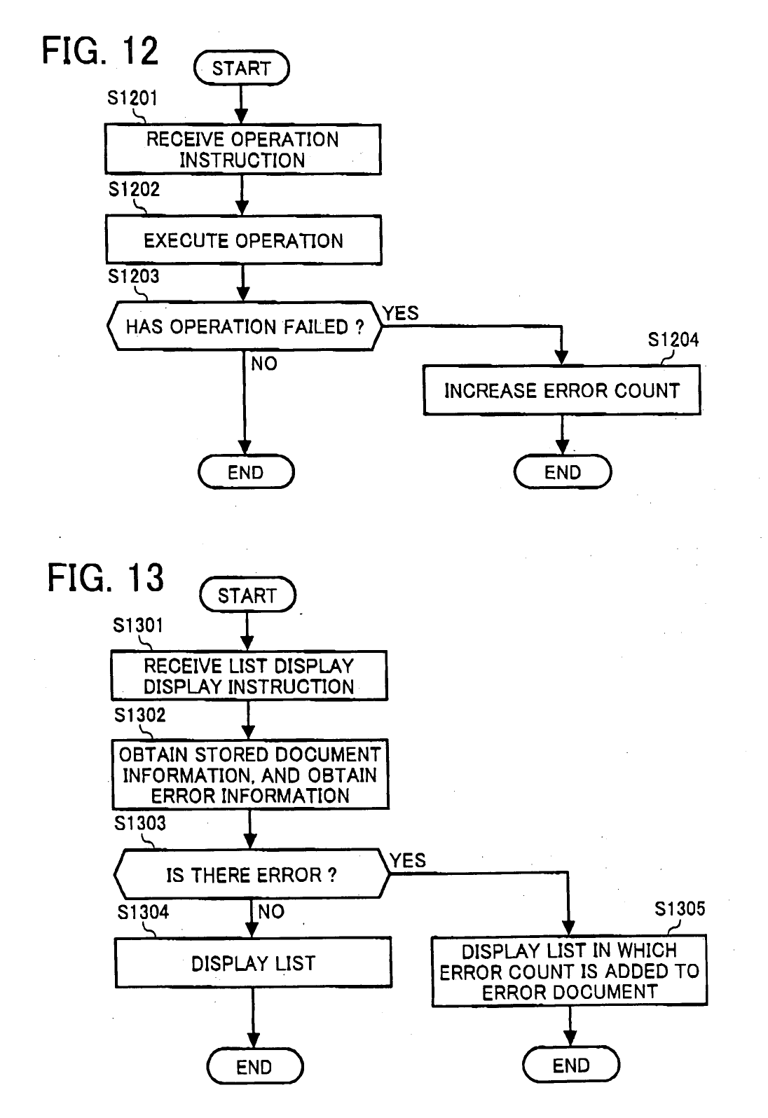

FIG. 12 is a flowchart of a processing to perform an operation for a document in the image forming apparatus according to a fifth embodiment of the present invention. As shown in FIG. 12, when the CPU 3 receives an instruction to perform an operation, such as printing and deletion, on a document selected from among documents stored in the document storage unit 7 via the display operation unit 17 (step 1201), the CPU 3 executes the operation (step 1202). After executing the operation, the CPU 3 determines whether the operation has failed to be completed (step 1203), and when the operation has failed, records an error on the failed document in the error-information storage unit 9, by increasing an error count of the failed document (step 1204).

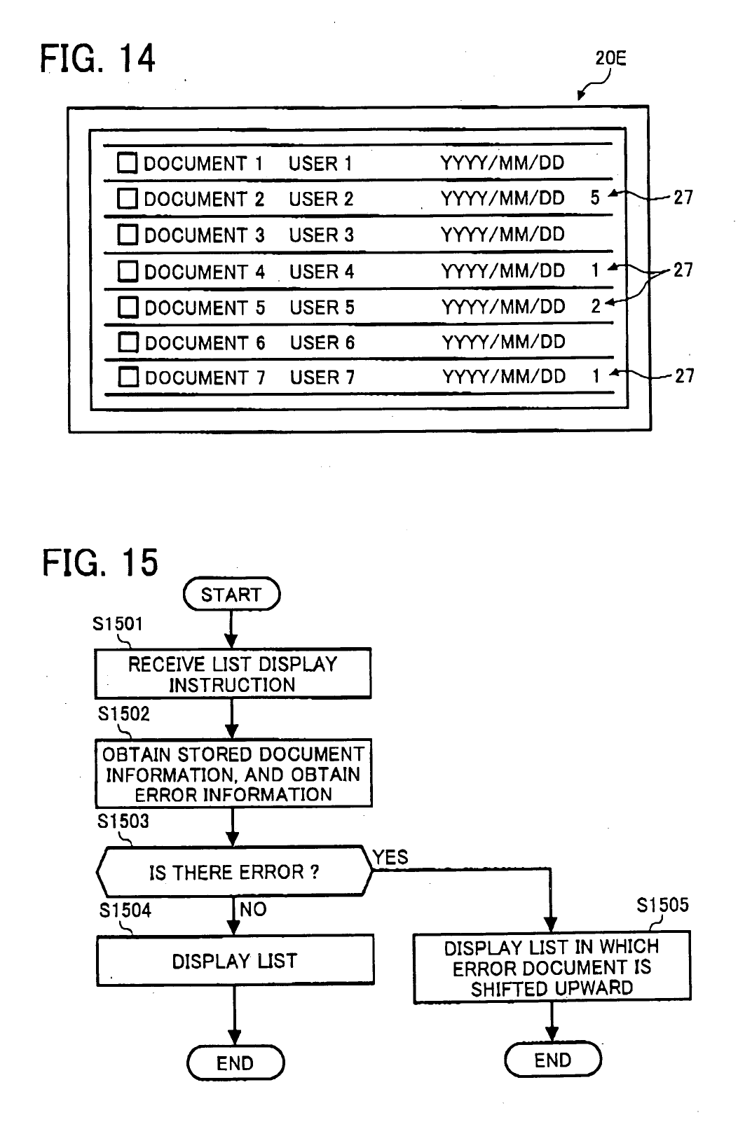

FIG. 13 is a flowchart of a list display operation in the image forming apparatus according to the fifth embodiment. FIG. 14 is a schematic of a list in which an error count 27 is added to a failed document. As shown in FIG. 13, upon receiving an instruction to display a list of stored documents via the display operation unit 17 (step 1301), the CPU 3 obtains information on the stored documents from the document storage unit 7, and the error information indicating a failed document from the error-information storage unit 9 (step 1302). The CPU 3 then determines whether there is error information indicating a failed document in the error-information storage unit 9 (step 1303). When there is no failed document, the CPU 3 displays the list 20 as shown in FIG. 4 (step 1304). When there is a failed document, the CPU 3 displays, as shown in FIG. 14, a list 20E in which the error count 27 is added to the failed document on the list, according to the error information, (step 1305).

Since the error count 27 is added to the failed document on the list, the failed documents and the number of failure can be easily understand, thereby improving the operability when some operation is to be performed again on the failed document.

A processing to perform an operation for a document in an image forming apparatus according to a sixth embodiment of the present invention is the same as that explained in the first embodiment.

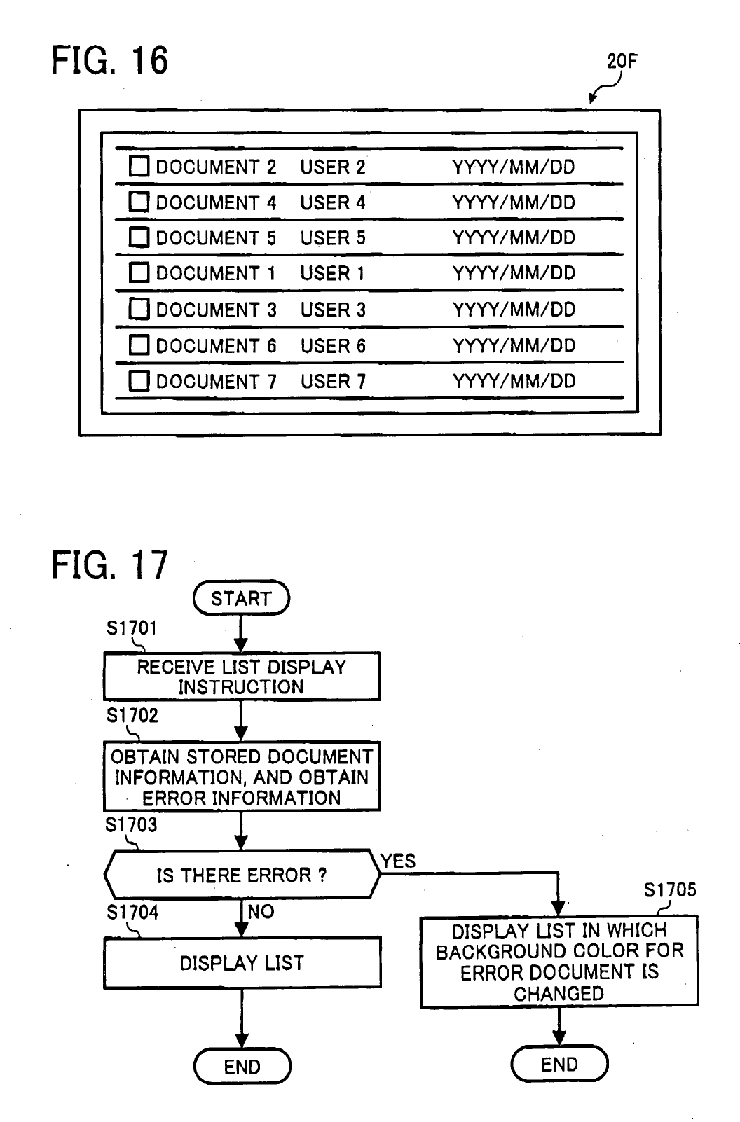

FIG. 15 is a flowchart of a list display operation in the image forming apparatus according to the sixth embodiment. FIG. 16 is a schematic of a list in which the failed documents are listed on the top. As shown in FIG. 15, upon receiving an instruction to display a list of stored documents via the display operation unit 17 (step 1501), the CPU 3 obtains information on the stored documents from the document storage unit 7, and the error information from the error-information storage unit 9 (step 1502). The CPU 3 then determines whether there is error information indicating a failed document in the error-information storage unit 9 (step 1503), and when there is no error information indicating a failed document, the CPU 3 displays the list 20 as shown in FIG. 4 (step 1504). When there is a failed document, the CPU 3 displays, as shown in FIG. 16, a list 20F in which the failed documents (documents 2, 4, 5) are shifted upward to be displayed on the top of the list, according to the error information (step 1505). Thus, the failed documents can be easily found.

Since the failed documents are displayed on the top of the list, the failed documents can be easily found, thereby improving the operability when some operation is to be performed again on the failed document.

A processing to perform an operation for a document in an image forming apparatus according to a seventh embodiment of the present invention is the same as that explained in the first embodiment.

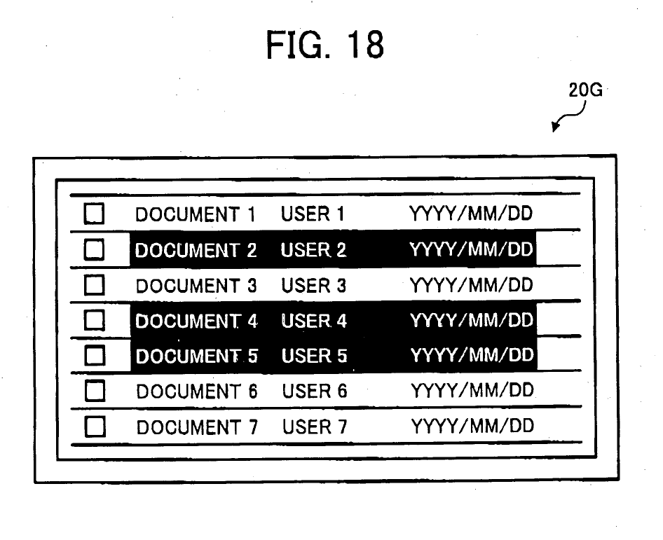

FIG. 17 is an operation flowchart of displaying the list screen by the image forming apparatus according to the seventh embodiment. FIG. 18 is a schematic of a list of documents in which a background color of the failed documents is different from documents for which the operation has succeeded. As shown in FIG. 17, upon receiving an instruction to display a list of stored documents via the display operation unit 17 (step 1701), the CPU 3 obtains information on the stored documents from the document storage unit 7, and the error information from the error-information storage unit 9 (step 1702). The CPU 3 then determines whether there is error information indicating a failed document in the error-information storage unit 9 (step 1703). When there is no error information indicating a failed document, the CPU 3 displays the list 20 as shown in FIG. 4 (step 1704). When there is a failed document, the CPU 3 displays, as shown in FIG. 18, a list screen 20G in which a background color of the failed documents (documents 2, 4, 5) is made different from a background color of documents for which the operation has succeeded, according to the error information. Thus, the failed documents can be easily found (step 1705).

Since the background color for the failed documents is changed to a different color from that of documents for which the operation has succeeded on the list, the failed documents can be easily found, thereby improving the operability when some operation is to be performed again on the failed documents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that stores at least one document, and that performs an operation for the document by specifying a document for which the operation is to be performed from a list of documents displayed, comprising:
an error-information storage unit configured to store an error information that includes information on a document for which the operation has failed to be completed; and
a display unit configured to display the list while discriminating the documents for which the operation has failed from documents for which the operation has succeeded, based on the error information.

2. The image forming apparatus according to claim 1, wherein the display unit is configured to discriminate the document for which the operation has failed by displaying the document for which the operation has failed in a selected state.

3. The image forming apparatus according to claim 1, wherein
the list includes an error display button, and
the display unit is configured to display an error list of only the document for which the operation has failed when the error display button is operated.

4. The image forming apparatus according to claim 1, wherein the display unit is configured to discriminate the document for which the operation has failed by adding an error icon indicating that the operation has failed to be completed.

5. The image forming apparatus according to claim 1, wherein the display unit is configured to add an error count indicating the number of failure of the operation for each of the document.

6. The image forming apparatus according to claim 1, wherein the display unit is configured to display the document for which the operation has failed collectively at a predetermined position on the list.

7. The image forming apparatus according to claim 1, wherein the display unit is configured to display the document for which the operation has failed with a background color different from that of documents for which the operation has succeeded.
